(19) United States
(12) Patent Application Publication
(10) Pub. No.: US 2006/0190457 A1
(43) Pub. Date: Aug. 24, 2006

(54) Method of increasing enterprise alliance and cooperation success

(76) Inventor: Pien Chien, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,679

(22) Filed: Jan. 13, 2005

(51) Int. Cl. G06F 17/30; G06F 7/00

(52) U.S. Cl. 707/10

(57) ABSTRACT

A method of increasing enterprise alliance or successful cooperation comprising collecting the basic information and the news information of several target units. According to the above basic information, the target units are classified into several classifications. An assessment is performed based on the above news information and the basic information, thereby generating several items and the item points. The corresponding classifications, the items and the items points of above target unit are stored. A plurality of electronic mails is transmitted to a portion of the target units depending on the above classifications, items and above items points. Therefore, some common consensuses are obtained or some titles are prepared from the specific contents of the electronic mails returned by the targeted partners.

### BACKGROUND OF THE INVENTION

1. Field of the Invention

The present invention relates to a method of increasing enterprise alliance and cooperation success, and more particularly, to a method of increasing enterprise alliance and cooperation success via an internet network.

2. Description of the Prior Art

The past two decades have seen an emphasis on businesses gaining important competitive advantages. During this time, a significant amount of business research by academics, and applications by practitioners, have been centered on conceptualizing and formulating various competitive strategies. Electronic mail (“email”) messaging systems have become core applications in many enterprises. The trend toward e-commerce began some 25 years ago, when larger corporations began transacting business with subsidiaries and suppliers over private networks. Recently, e-commerce has become more synonymous with business carried out over the Internet, through webs sites, for example, to sell goods, services, and information to consumers.

### SUMMARY OF THE INVENTION

The present invention provides a method of increasing enterprise alliance and successful cooperation in order to reduce blocks or bottlenecks while performing the business strategy. By collecting information of potential cooperation partners or enterprises, the information is classified into several items or groups and the items are pointed to by using the analysis of the business strategy, thereby obtaining the cooperation or identifying the enterprises which match the business strategy.

The present invention also provides a method of increasing enterprise alliance and successful cooperation, in which the cooperating enterprises which are matched to the business strategy are chosen rapidly and electronic mail is automatically transmitted to the chosen cooperation partner or enterprise after the data is sifted and assessed to identify the potential cooperation partner or the enterprise, in order to communicate the common consensuses.

The present invention also provides a method of online-choosing the enterprise alliance or successful cooperation partner, which matches the cooperation partner or enterprises or the product or the business strategy to the disposed cooperation or the enterprises, thereby obtaining the information rapidly.

According to a preferred embodiment of the present invention, a method of increasing enterprise alliance or successful cooperation is provided, which comprises collecting basic information and news information of several target units. According to the above basic information, the target units are classified into several classifications. An assessment is performed based on the above news information and the basic information, thereby generating several items and item points. The corresponding classifications, the items and the items points of the target unit are stored. A plurality of electronic mails is transmitted to a portion of the target units depending on the classifications, items and items points. Therefore, some common elements or consensuses are obtained or some titles are prepared from the specific contents of the electronic mails.

These and other objectives of the present invention will become obvious to those of ordinary skill in the art after reading the following detailed description of the preferred embodiment.

It is to be understood that both the foregoing general description and the following detailed description are exemplary, and are intended to provide further explanation of the invention as claimed.

### BRIEF DESCRIPTION OF THE DRAWINGS

The accompanying drawing is included to provide a further understanding of the invention, and are incorporated in and constitute a part of this specification. The drawing illustrates one embodiment of the invention and, together with the description, serve to explain the principles of the invention. In the drawing,

FIG. 1 is a flow chart of performing a method of increasing enterprise alliance via the internet network according to and embodiment of the present invention.

### DETAILED DESCRIPTION OF THE PREFERRED EMBODIMENTS

The present invention provides a method of increasing enterprise alliance and successful cooperation partners via an internet network. A wet site interface is provided on the internet network. The basic information and the news information of several target units are collected via the internet network. Depending on the above basic information, the target units are classified into a plurality of classifications. An assessment of the plurality of news information and the plurality of basic information is performed, thereby generating the items and the item fractions. Next, the correspondingly classifications, items and item fractions of target units are stored into at least one database, wherein the web site interface is connected to the database. Also, depending on the classifications and the items and the item fractions, a portion of the target units is selected. The electronic mails are transmitted to the selected target units. The reply contents are received, wherein the reply contents correspond to a portion of electronic mails.

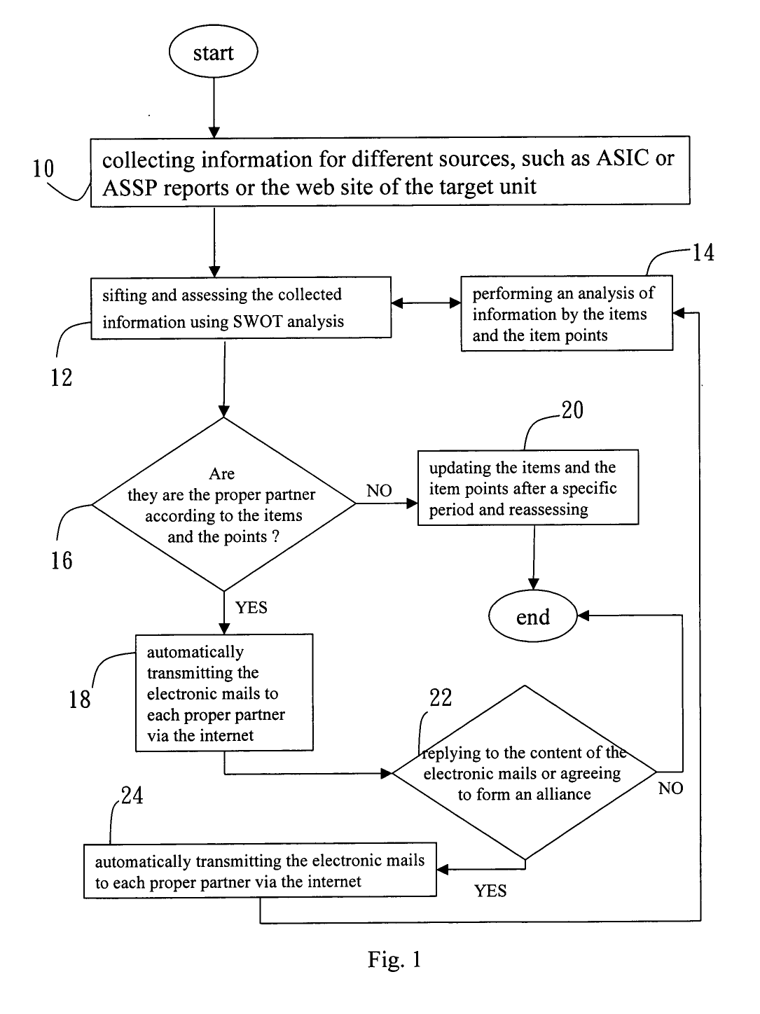

Refer to FIG. 1, in which a flow chart of the present invention is shown. In an embodiment of the present invention, a method of increasing enterprise alliance or successful cooperation partners via an internet network in an enterprise unit is achieved. Firstly, the basic information of several target units is collected from the different sources (the step 10). In this preferred embodiment, the enterprise unit is a corporation which applies the present invention, for example, a semiconductor foundry company. The different sources comprise resources from the enterprise unit itself, for example, a database from the intranet in the enterprise unit, or other enterprise units connected by the internet network, for example, digital resources provided from a consulting company, a venture capital company or an alliance organization (ASIC or ASSP). In the present invention, the target unit which is going to be collected is a company or corporation regarding the business of the enterprise unit. In this embodiment, the target unit comprises a design house, a manufacturer, or foundry industry. In the present invention, the data information of the target unit comprises the basic information and news information of a target unit. The basic information comprises capital amount, staff, operating revenue, technical resources, intellectual property, and contacting information. The news information comprises news regarding the above target units, for example, the annual roadmap, the world ranking, the national ranking, the assessment of the enterprise, and so on.

The collected data of the target unit is sifted and assessed (step 12). In the preferred embodiment, the collected data is sifted by a preliminary classification depending on the business item of the target unit in order to catch the proper target unit in the specific alliance or the cooperation level. Then, the collected data is assessed based on the basic information and news information of each target unit in order to assess the target unit. The values of each target unit are represented by several items and the obtained points. It should be noted that the represented values of each target unit have variations because the business item of each target unit and the collected basic information of each target unit are different. However, basically, the items and the points of the target unit in the specific alliance or the cooperation level are obtained by the same assessment way.

One advantage of the present invention is that the basic information and the news information of the target unit are assessed by using several objective assessment tools to integrate into several quantifiable items and points. In the present invention, the SWOT is used to analyze the target unit. The so-called “SWOT” tool is an acronym for Strengths, Weaknesses, Opportunities, and Threats. These strengths and weaknesses reflect characteristics of the organization which may be attributed to its internal makeup/constitution. These opportunities and threats reflect characteristics of the organization's environment. For instance, an exemplary opportunity may identify a market segment that is current under-exploitation by competitors, thus representing an opportunity for exploitation by the organization. An exemplary threat may identify any type of potential impediment to the organization's profitability, such as competitive threats, regulative threats, etc. In this preferred embodiment of the present invention, the basic information and news information of each target unit are integrated to perform several assessments, such as technology assessment, market assessment, timely assessment, national policy assessment, intellectual property assessment (the step 14) and so on. The assessed results are presented by several items and item points. These items and the item points comprise the professional ability, the technological ability, the market competitive ability, the strategic capital assets, the IP performance, the finance strength, and so on, which are stored in the server from the enterprise unit (or the database) and updated on a regular basis or at any time according to the latest information and news.

Taking the Intellectual Property Vendors as the target units for an example, when a SWOT analysis is performed, the collected information about the vendors is integrated into several items, such as the IP fee, the IP income, the IP performance, the finance strength, the back-end design support, the IP development time and schedule, and so on. Several IP vendors are assessed by using these items to generate the item points for each IP vendor.

Next, according to the results after being sifted and assessed, which are the items and the item points of the target unit of the specific alliance or the cooperation level, the proper partners are chosen (the step 16). In the present invention, the business target of the enterprise unit is a reference for choosing the proper partners, and the business roadmap of the enterprise unit also is a reference for choosing the proper partners. In another embodiment of the present invention, according to the items and the points of the target unit, it provides the services to the above target unit or the enterprise unit for choosing the proper partners via e-commerce. It should be noted that the target unit or the enterprise unit can view the specific items and the item points via a payment system on the website interface provided by the enterprise when the enterprise provides the service for a target unit or the enterprise unit.

When the proper partners are chosen from the target unit, the enterprise unit can automatically transmit the electronic mails to each proper partner via the internet (step 18). The contents of the electronic mails comprise the different titles or contact items, such as a case earmarked for discussion, the title of a Summit, the strategic alliance, the alliance information and so on. An advantage of the present invention is that the enterprise can voluntarily contact the potential proper partners based on the business roadmap and the strategy of the target unit after the information is sifted and assessed. Some common consensuses are obtained about the relative business items and issues to increase the chance for cooperation and alliance. In addition, these electronic mails also can be stored in a database or added into the basic information or news information of the target unit for updating the items and the item points. When the proper partners reply to the contents of the electronic mails, the replied contents also can be stored into the database for updating the items and the item points.

If an alliance cannot be formed between the above proper partners and the enterprise or the proper partners that were chosen (the step 20) due some reason, a memorandum is used in the present invention After a specific time, the items and the item points of this targets unit are updated and reassessed, thereby keeping a good relationship by transmitting electronic mails to these target units periodically or casually in order to cooperate or ally in the future.

The present invention also provides an online communication system if the proper partners decided by the present invention to form a cooperation or an alliance relationship, thereby registering via the website interface of the enterprise unit to be exclusive members (the step 22). The enterprise unit provides the information to the specific member according to the specific member, such as the payment level. The enterprise unit also provides various online real-time services to the exclusive members, for example, design information of products and manufacturing are provided to the exclusive members.

The embodiment above is only intended to illustrate the present invention; it does not, however, to limit the present invention to the specific embodiment. Accordingly, various modifications and changes may be made without departing from the spirit and scope of the present invention as described in the following claims.

What is claimed is:

1. A method of increasing enterprise alliance or successful cooperation, comprising:
collecting a plurality of basic information and a plurality of news information of a plurality of target units;
classifying the plurality of target units into a plurality of classifications depending on the plurality of basic information;
performing an assessment of the plurality of news information and the plurality of basic information, thereby generating a plurality of items and a plurality of item fractions;
storing the plurality of classifications, the plurality of items and the plurality of item fractions corresponding to the plurality of target units; and
transmitting a plurality of electronic mails to a portion of the plurality of target units depending on the plurality of classifications, the plurality of items and the plurality of item fractions.

2. The method of increasing enterprise alliance or successful cooperation of claim 1, further comprising receiving a matching request from an enterprise unit.

3. The method of increasing enterprise alliance or successful cooperation of claim 2, wherein transmitting the plurality of electronic mails to the portion of the plurality of target units comprises selecting a portion of the target units depending on the matching request.

4. The method of increasing enterprise alliance or successful cooperation of claim 1, further comprising receiving a plurality of reply contents of the portion of the plurality of electronic mails.

5. The method of increasing enterprise alliance or successful cooperation of claim 4, further comprising adding the plurality of reply contents into the corresponding plurality of news information of the plurality of target units.

6. The method of increasing enterprise alliance or successful cooperation of claim 4, further comprising modifying the corresponding plurality of item fractions of the plurality of target units depending on the plurality of reply contents.

7. The method of increasing enterprise alliance or successful cooperation of claim 1, further comprising providing a web site interface for displaying the plurality of classifications, the plurality of items and the plurality of item fractions.

8. The method of increasing enterprise alliance or successful cooperation of claim 7, further comprising receiving a plurality of reply contents of the portion of the plurality of electronic mails.

9. The method of increasing enterprise alliance or successful cooperation of claim 7, further comprising allowing the web site interface to log into the web site depending on the plurality of reply contents.

10. A method of increasing enterprise alliance or successful cooperation, which is performed by an internet network, comprising:
providing a web site interface on the internet network;
collecting a plurality of basic information and a plurality of news information of a plurality of target units via the internet network;
classifying the plurality of target units into a plurality of classifications depending on the plurality of basic information;
performing an assessment of the plurality of news information and the plurality of basic information, thereby generating a plurality of items and a plurality of item fractions;
storing the plurality of classifications, the plurality of items and the plurality of item fractions corresponding to the plurality of target units into at least one database, wherein the web site interface is connected to the database;
selecting a portion of the plurality of target units depending on the plurality of classifications and the plurality of items and the plurality of item fractions;
transmitting a plurality of electronic mails to the selected target units; and
receiving a plurality of reply contents, wherein the plurality of reply contents is corresponding to the plurality of electronic mails.

11. The method of increasing enterprise alliance or sucessful cooperation of claim 10, further comprising allowing the web site interface to log into the web site depending on the plurality of reply contents.

12. The method of increasing enterprise alliance or successful cooperation of claim 10, further comprising adding the plurality of reply contents into the corresponding plurality of news information of the plurality of target units.

13. The method of increasing enterprise alliance or successful cooperation of claim 10, further comprising modifying the corresponding plurality of item fractions of the plurality of target units depending on the plurality of reply contents.

14. The method of increasing enterprise alliance or successful cooperation of claim 10, wherein the plurality of news information comprises displaying the plurality of items and the plurality of item fractions on the web site interface.
